(19) United States
(12) Patent Application Publication
(10) Pub. No.: US 2017/0095929 A1
(43) Pub. Date: Apr. 6, 2017

(54) SYSTEM FOR CHECKING CALIBRATION OF A ROBOTIC MULTI-AXIS MACHINE

(71) Applicant: General Electric Company, Schenectady, NY (US)

(72) Inventors: Lawrence Matthew Levy, Simpsonville, SC (US); Jon E. Dickinson, Rotterdam, NY (US); Patrick Thomas Walsh, Simpsonville, SC (US)

(21) Appl. No.: 14/876,027

(22) Filed: Oct. 6, 2015

(51) Int. Cl. B25J 9/16

(52) U.S. Cl. CPC B25J 9/1692; G05B 2219/39033

(57) ABSTRACT

A system for checking calibration of a multi-axis machine includes a robotic arm and a mount configured to receive a removable machine tool and a controller electronically connected to the multi-axis machine. The removable machine tool includes a removable spray nozzle and a laser housing that is coupled to the machine tool. The laser housing includes a laser affixed inside the housing for emitting a laser beam and a calibration workpiece coupled to a mounting table. The calibration workpiece comprises a plurality of laser sensors disposed along an outer surface of the calibration workpiece. The controller is programmed to point the laser beam at each laser sensor. The laser sensors generate signals that are communicated back to the controller if the laser beam is detected by the laser sensor.

### FIELD OF THE INVENTION

The present invention generally involves a multi-axis robotic machine. More particularly, the invention relates to a system for checking or verifying calibration of the multi-axis robotic machine.

### BACKGROUND OF THE INVENTION

Robotic machine tools exist in various configurations for performing various manufacturing operations in the production of various machine components. A typical machine tool is supported in/on a multi-axis robotic machine or robot for following a programmed path over the contours of a three dimensional workpiece. In particular configurations, the workpiece may be mounted to a multi-axis (2-axis) moveable mounting table thus providing up to eight degrees of movement. The multi-axis machine and the mounting table may be programmed to manipulate the machine tool and the workpiece in concert so as to precisely machine the surface contour of the workpiece to a specific shape, weld the workpiece at specific locations on the contour, or may be programmed to manipulate a plasma torch of spry gun to apply a coating to a surface of the workpiece.

In one exemplary configuration, the multi-axis machine includes a plasma torch or gun that is mounted to a distal end of an articulated robotic arm having multiple degrees of movement such as translation or rotation or both. The multi-axis machine and the mounting table may be programmed together to orient the plasma gun towards the surface of the workpiece and follow a programmed path for automatically plasma spraying the workpiece with a suitable material.

The workpiece may be a gas turbine engine component such as stator vane or turbine rotor blade having a complex 3-D contour requiring the deposition of a thermal barrier coating thereon by plasma spraying. In order to plasma spray a uniform coating over the entire surface of the workpiece, the plasma gun must follow a precise preprogrammed spraying path while maintaining a suitable offset or standoff from the surface of the workpiece. Therefore, the multi-axis machine and the mounting table must be suitably calibrated for ensuring accuracy of the programmed path relative to an individual workpiece.

Over time, the multi-axis machine and/or the mounting table may fall out of calibration. One known technique for checking if the multi-axis machine and/or the mounting table are calibrated includes removing the machine tool such as the spray gun and attaching a calibration kit to the multi-axis machine and may require cleaning of the multi-axis machine and/or the machine tool to be precise. Once the multi-axis machine is calibrated it is then possible to check the calibration of the multi-axis mounting table.

Although effective, this process for checking calibration is time consuming and may not be necessary if the multi-axis machine and the mounting table are in calibration.

### BRIEF DESCRIPTION OF THE INVENTION

Aspects and advantages of the invention are set forth below in the following description, or may be obvious from the description, or may be learned through practice of the invention.

One embodiment of the present invention is a system for checking calibration of a multi-axis machine. The system includes a multi-axis machine having a robotic arm and a mount that is coupled to a distal end of the robotic arm. The mount is configured to receive a removable machine tool and the multi-axis machine is electronically connected to a controller. The system also includes a laser housing that is coupled to the removable machine tool. The laser housing includes a laser affixed inside the laser housing for emitting a laser beam. A calibration workpiece is coupled to a mounting table and includes a plurality of laser sensors disposed along an outer surface of the calibration workpiece. The controller is programmed to point the laser beam at each laser sensor and each laser sensor generates a signal that is communicated back to the controller if the laser beam is detected by the laser sensor.

The present invention also includes a method for checking calibration of a robotic multi-axis machine. The method includes coupling a laser pointer to a machine tool that is mounted to a distal end of a robotic arm of a robotic multi-axis machine. The method also includes initiating a calibration program programmed into the controller which instructs the robotic multi-axis machine to point the laser pointer towards a laser sensor disposed along an outer surface of a calibration workpiece and generates a laser beam via a laser of the laser pointer. If the laser sensor detects the laser beam the laser sensor generates a signal which is transmitted back to the controller and the controller records the signal. If the laser beam fails to strike the intended laser sensor, a signal will not be generated.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a schematic of a robotic multi-axis machine including a multi-axis articulated robotic arm whose position is operatively controlled by a programmable controller;

FIG. 2 is an enlarged and exploded view of the working end of the exemplary machine tool illustrated in FIG. 1, and an interchangeable laser pointer therefor in accordance with an exemplary embodiment;

FIG. 3 is an axial sectional view through the laser pointer illustrated in FIG. 2 and taken along line 3-3;

FIG. 4 is an enlarged and exploded view of the working end of the exemplary machine tool illustrated in FIG. 1, and an interchangeable laser pointer therefor in accordance with another exemplary embodiment.

FIG. 5 illustrates schematically the system in use for verifying or checking calibration of the robotic multi-axis machine and a mounting table; and

FIG. 6 is a block diagram including a method for checking calibration of the robotic multi-axis machine as shown in FIGS. 1-5.

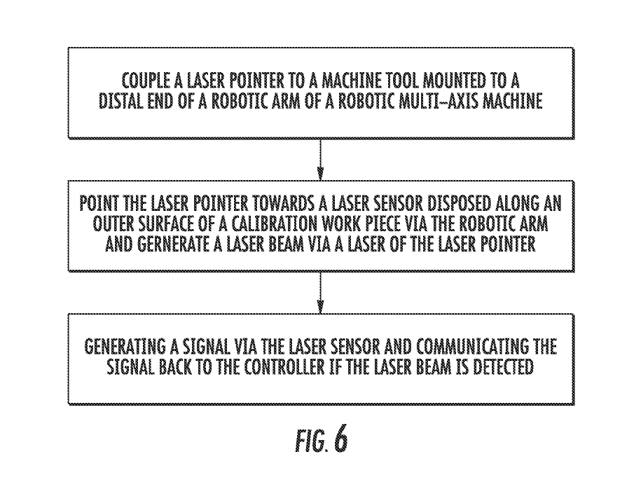

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents. Although exemplary embodiments of the present invention will be described generally in the context of a robotic multi-axis machine tool or robot and mounting table with a gas turbine component provided as an exemplary calibration workpiece for purposes of illustration, one of ordinary skill in the art will readily appreciate that embodiments of the present invention may be applied to any type of calibration workpiece and are not limited to a gas turbine calibration workpiece unless specifically recited in the claims.

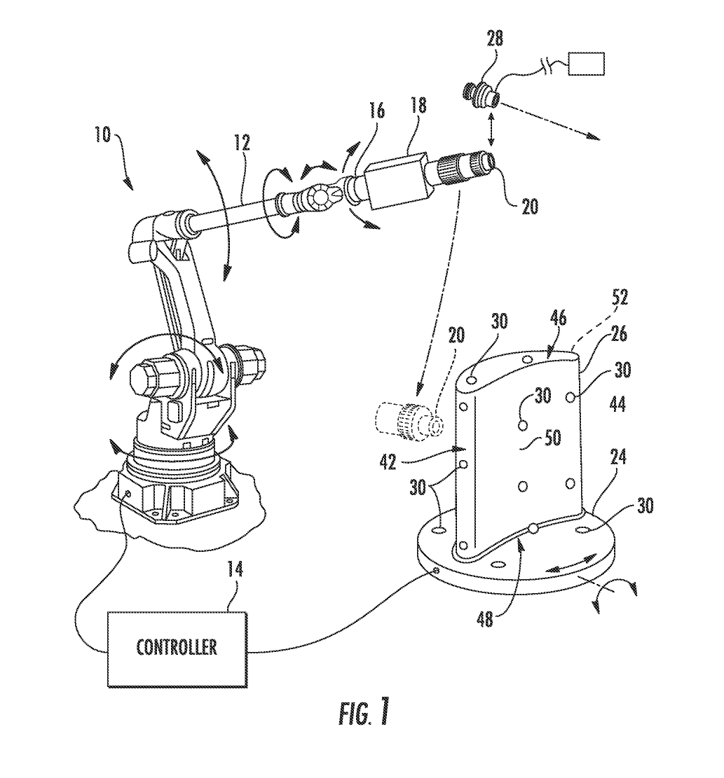

Referring now to the drawings, wherein identical numerals indicate the same elements throughout the figures, FIG. 1 provides a schematic of a robotic multi-axis machine 10 including a multi-axis articulated robotic arm 12 whose position is operatively controlled by a programmable controller 14. The machine 10 may have any conventional configuration for performing various machining operations as desired including machining, welding, and plasma spraying, for example. Such machines are commonly referred to as computer numerical control (CNC) or digital numerical control (DNC) machines in which their various machining operations may be programmed in software, and stored in suitable memory within the controller for automatic operation thereof. In the exemplary embodiment illustrated in FIG. 1, the robotic arm 12 is articulated at several joints to effect six axes of movement of a mount 16 disposed at the distal end of the arm. The corresponding six degrees of movement are all rotary as indicated by the six double headed arrows illustrated in FIG. 1.

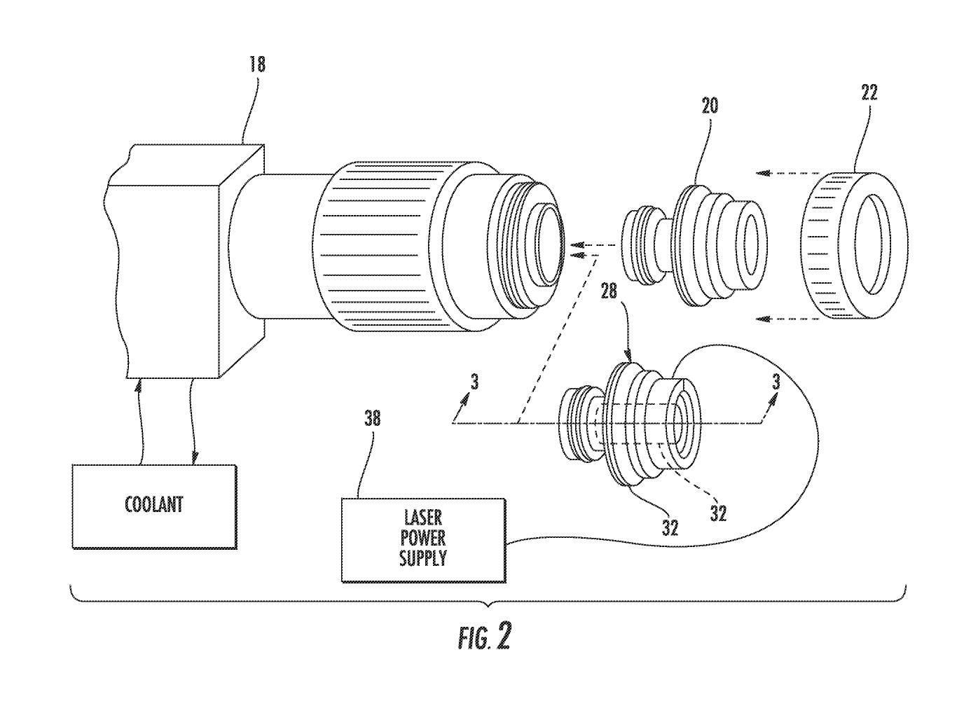

A machine tool 18 in the exemplary form of a plasma spray gun is supported in the mount 16 and is removable therefrom. The plasma spray gun may include a main body which is suitably water cooled. The plasma spray gun may also include a plasma spray nozzle 20 mounted thereto and removable therefrom as illustrated in more detail in FIG. 2.

FIG. 2 is an enlarged and exploded view of the working end of the exemplary machine tool 18 illustrated in FIG. 1, and an interchangeable laser pointer therefor in accordance with an exemplary embodiment. As shown in FIG. 2, the plasma nozzle 20 may be generally cylindrical and configured for being inserted into a corresponding barrel of the plasma gun and may include a retaining nut 22 being used for threadingly securing the nozzle to the gun barrel. The plasma nozzle 20 may include suitable O-rings for providing a fluid seal with the barrel and sealing therein the water coolant circulated during operation for cooling the plasma gun if so equipped.

Referring back to FIG. 1, the machine 10 also includes a mounting table 24 on which a calibration workpiece 26 may be suitably mounted. In the exemplary embodiment, the mounting table 24 introduces two additional degrees of movement including rotation of the table and tilting thereof which when combined with the six degrees of movement of the robotic arm 12 effect a total of eight degrees of movement between the arm and table. In this way, the plasma gun, and in particular its plasma nozzle 20, may be directed at any location over the exposed surface of the calibration workpiece 26 mounted to the table 24.

The robotic multi-axis machine 10 described above and the calibration workpiece 26 may have any conventional configuration. For example, the calibration workpiece 26 is in the exemplary form of a gas turbine engine turbine stator vane which has an airfoil contour including a generally concave pressure side and a generally convex opposite suction side extending longitudinally from root to tip between leading and trailing edges of the vane.

Since the vane is subject to hot combustion gases during operation in a gas turbine engine, it is desired to coat the vane with a ceramic thermal barrier coating which is conventionally applied using plasma spray deposition effected by the plasma spray gun 18. The vane is merely one of a substantial number of vanes required in a single gas turbine engine which may be plasma spray coated using the machine 10. However, plasma spray coating of the vane requires precise orientation of the plasma nozzle 20 relative to the surface of the vane, and the nozzle must be precisely traversed over the entire surface of the vane for completing the spray coating thereof.

In order to verify the calibration of the machine 10, as shown in FIGS. 1 and 2 collectively, a laser pointer 28 is provided in accordance with the present invention for use with the otherwise conventional robotic machine 10 and a plurality of laser sensors 30 are provided on the calibration workpiece 26 and/or the mounting table 24. The laser sensors 30 may comprise of any laser sensor suitable for the application as described herein. For example, in the exemplary embodiment, the laser sensors 30 may be diode laser sensors. The laser sensors 30 may be placed at various X, Y, Z coordinates.

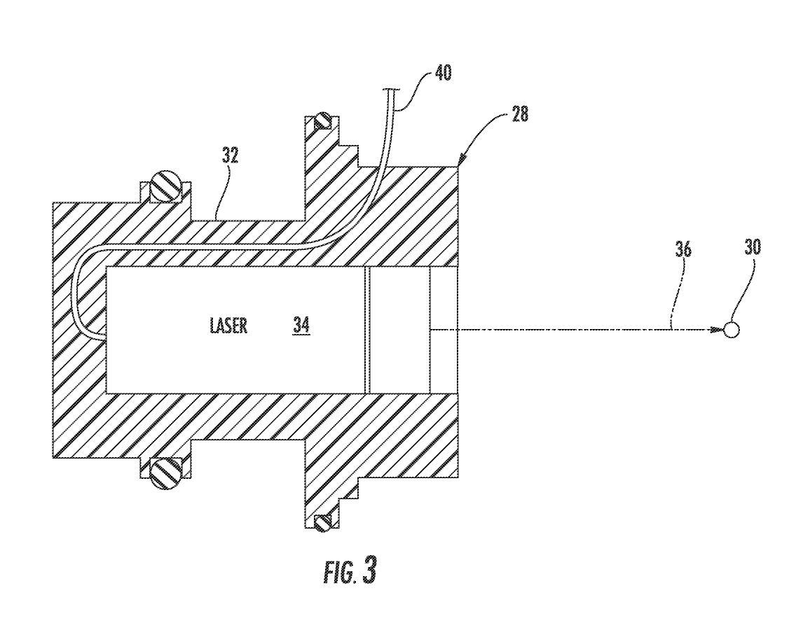

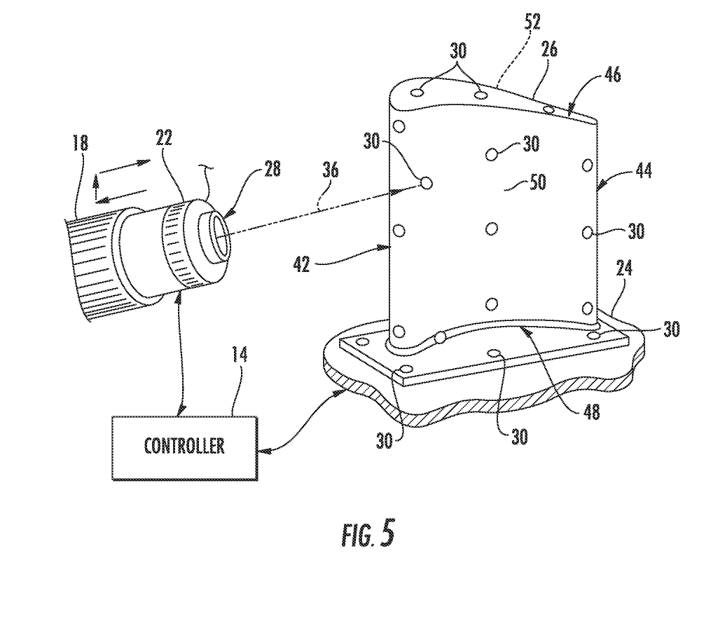

FIG. 3 is an axial sectional view through the laser pointer 28 illustrated in FIG. 2 and taken along line 3-3. In one embodiment, as shown in FIGS. 2 and 3, the laser pointer 28 includes a cylindrical housing 32 configured like the plasma nozzle 20, and is preferably initially identical thereto. In this way, the housing 32 may be coupled to or directly interchanged with the plasma nozzle 20 within the plasma gun barrel as an identical replacement, except that it is not configured for use as a plasma spray nozzle. Instead, a laser 34 is affixed in the housing for emitting a laser beam 36 (FIG. 3) at the calibration workpiece 26, particularly at the laser sensors 30 as illustrated in more particularity in FIG. 5.

As illustrated in FIGS. 2 & 3, the laser 34 is preferably fixedly mounted inside the housing 32, and may include a remote power supply 38 (FIG. 2) operatively joined to the laser 34 by a suitable power line or cable 40 (FIG. 3). In this way, a conventional mini-laser may be mounted within the available space of a conventional plasma spray nozzle 20 with its power being provided remotely from the power supply 38, which may be battery operated with a manual on and off switch for energizing the laser when desired. The laser 34 may have any conventional form such as a red or blue diode laser for emitting a visible red or blue laser beam respectfully. In particular embodiments, the laser 34 may be a focused laser. By mounting the laser 34 within the bore of the housing 32, the laser beam 36 accurately reproduces the orientation of the plasma spray which would otherwise be emitted from the unmodified plasma spray nozzle used for creating the housing.

The housing 32 may be axially split at one circumferential location as illustrated in FIGS. 2 and 3, and the bore of the housing 32 is suitably machined as required for receiving the laser 34 in a suitably tight interference fit. The split housing may introduce elasticity for tightly receiving the laser 34 within the housing bore without damaging the laser 34. The inlet end of the housing 32 and the axial split may be filled with a suitable sealant, such as silicone, for sealingly mounting the laser 34 within the housing 32.

As indicated above, the advantage of using a second plasma spray nozzle, like the nozzle 20, for the housing 32 is its almost identical configuration therewith for being mounted in the plasma gun barrel so that it may be suitably sealed within the barrel for containing the water coolant therein during operation. Like the original plasma nozzle 20, the housing 32 may include suitable O-ring seals which may seal the circumference of the housing to the gun barrel upon retention by the mounting nut 22 as illustrated in FIG. 2.

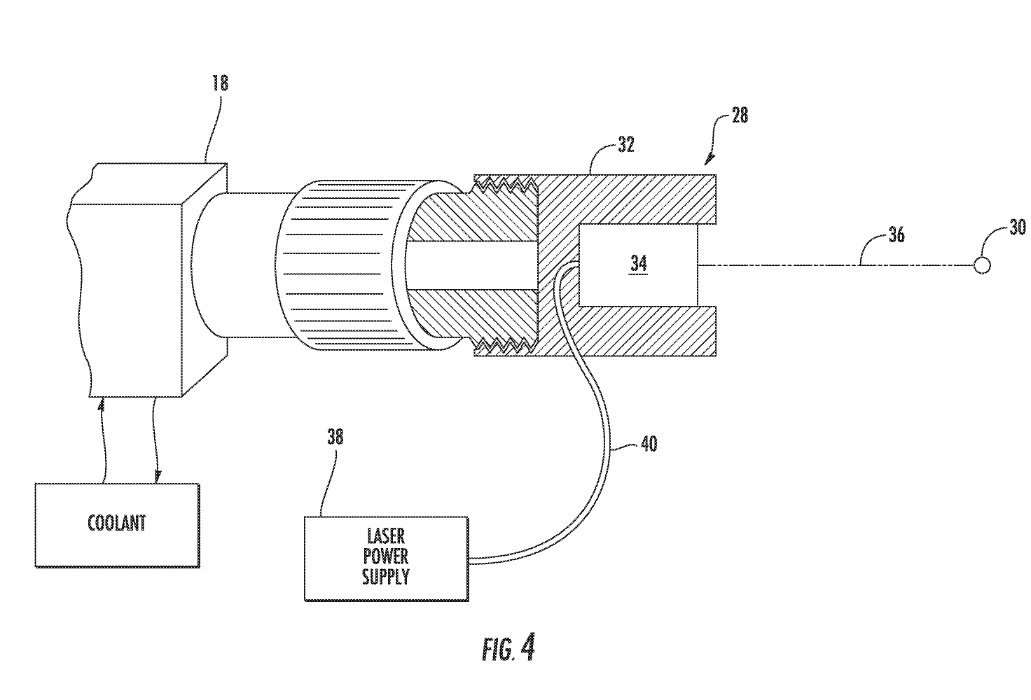

FIG. 4 is an enlarged and exploded view of the working end of the exemplary machine tool 18 illustrated in FIG. 1 including the laser pointer 28 in accordance with an exemplary embodiment of the invention. As shown in FIG. 4, the housing 32 of the laser pointer 28 may be coupled to an outer surface of the machine tool 18. For example, in one embodiment, an outer surface of the machine tool 18 and the housing 32 of the laser pointer 28 may be coupled together via complementary threads. In this manner, the plasma spray nozzle 20 may remain connected to the machine tool 18, particularly the plasma spray gun, thus reducing assembly time.

As shown in FIGS. 1 and 5, the laser sensors 30 may be disposed at various locations defined as calibration points on the calibration workpiece 26. For example, in the exemplary embodiment, the laser sensors 30 may be placed along any one or any combination of a leading edge portion 42, a trailing edge portion 44, a tip portion 46, a root portion 48, a pressure side portion 50 or a suction side portion 52 portion of the vane and/or along a base portion 54 of the calibration workpiece 26.

FIG. 5 illustrates schematically the system 100 in use for verifying or checking calibration of the robotic multi-axis machine 10 and the mounting table 24. Initially, the laser pointer 28 is mounted into the plasma gun 18 of the machine 10 in the same manner as the plasma spray nozzle 20 illustrated in FIG. 1 which it temporarily replaces and the calibration workpiece 26 is coupled to the mounting table 24. The multi-axis machine 10 may next be operated in a conventional manner to traverse or position the laser pointer 28 mounted to the robotic arm 12 so as to direct the laser beam 36 towards a specific laser sensor 30 disposed along the surface of the calibration workpiece 26 based on a calibration check program which may be programmed in suitable software within the controller 14. The path programmed into the controller 14 may have any suitable configuration which traverses the plasma spray gun path from laser sensor to laser sensor around the surface of the calibration workpiece 26 and which rotates the mounting table 24 through its various axis of rotation.

If the laser beam 36 strikes the intended laser sensor 30, the laser sensor 30 generates a signal which is transmitted back to the controller 14. The controller 14 records the signal as “acceptable” or “in-calibration” reading. If the laser beam 36 fails to strike the intended laser sensor 30, a signal will not be generated and the controller 14 will record a “no-go” or “out-of-calibration” reading. This system 100 allows an operator to check each axis of rotation independently to determine calibration status. In particular embodiments, intensity of the laser beam 36 may be measured via the laser sensors 30 and may be/recorded by the controller 14 to determine if the machine 10 is drifting out of calibration. For example, high or normal laser beam intensity may signal that the machine 10 and/or the mounting table 24 are within acceptable calibration tolerance limits, whereas low or non-normal laser beam intensity readings may indicate drift from the acceptable calibration tolerance limits.

The controller 14 may be programmed to produce a printout or electronic display of the readings to alert an operator as to calibration status of both the multi-axis machine 10 and the mounting table 24, thus allowing an operator to take appropriate actions, such as re-calibrate the multi-axis machine 10 and/or the mounting table 24 or to continue operation of the multi-axis machine 10 and the mounting table 24.

After use, the laser pointer 28 may be removed from the gun barrel and replaced with the plasma nozzle 20. The multi-axis machine 10 may then be operated in a conventional manner for plasma spraying (or other machine tool operation) of a manufactured workpiece using the plasma spray nozzle 20. The system illustrated in FIGS. 1-4 and described herein allows an operator to determine, relatively quickly compared to known calibration systems, if all 8 axis of the machine 10 and the mounting table 24 are within calibration. This quick calibration check acts as a go/no-go gage, saves time and simplifies current methods, thus encouraging operators to check calibration periodically and to reduce rework or inspection failures. FIG. 5 provides a block diagram including a method 100 for checking the calibration of the robotic multi-axis machine 10. At step 102, the method 100 includes inserting the laser pointer 28 into the bore of the machine tool 18 which is mounted to the distal end of the robotic arm 12. At step 104, method 100 includes initiating the calibration program which is programmed into the controller 14 and which instructs the robotic multi-axis machine 10 to point the laser pointer 28 towards one of the laser sensors 30 disposed along the outer surface of the calibration workpiece 26 and to generate the laser beam 36 via the laser 34 of the laser pointer 28. If the corresponding laser sensor 30 detects the laser beam 36, the laser sensor 30 generates a signal which is transmitted back to the controller 14 and the controller records the signal.

Method 100 may also include translating the calibration workpiece 26 via the multi-axis mounting table 24. Method 100 may include detecting intensity of the laser beam 36 via the laser sensors 30 and determining calibration drift based on the intensity of the laser beam 36. Method 100 may also include producing a printout or an electronic display indicating calibration status based on the signals generated. Method 100 may further include removing the laser pointer 28 from the bore of the machine tool 18 upon completion of the calibration program and replacing the laser pointer 28 with the spray nozzle 20.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for checking calibration of a multi-axis machine, the system comprising:
a multi-axis machine including a robotic arm and a mount coupled to a distal end of the robotic arm, wherein the mount is configured to receive a removable machine tool and wherein the multi-axis machine is electronically connected to a controller;
a laser housing coupled to the machine tool, wherein the laser housing includes a laser affixed inside the laser housing for emitting a laser beam; and
a calibration workpiece coupled to a mounting table, wherein the calibration workpiece comprises a plurality of laser sensors disposed along an outer surface of the calibration workpiece; and
wherein the controller is programmed to check calibration by pointing the laser beam at each laser sensor and wherein each laser sensor generates a signal that is communicated back to the controller if the laser beam is detected by the laser sensor.

2. The system as in claim 1, wherein the machine tool includes a bore, wherein the laser housing is disposed within the bore.

3. The system as in claim 1, wherein the laser housing is engaged with an outer surface of the machine tool.

4. The system as in claim 1, wherein the mounting table is rotatable about at least two axis.

5. The system as in claim 1, wherein the robotic arm is articulated via the multi-axis machine at multiple joints to effect six axes of movement of the mount.

6. The system as in claim 1, wherein the removable machine tool is a plasma spray gun.

7. The system as in claim 6, wherein the laser housing is shaped substantially similar to a removable spray nozzle of the plasma spray gun.

8. The system as in claim 1, wherein the laser is a diode laser and generates a visible laser beam.

9. The system as in claim 1, wherein the laser sensors are diode laser sensors.

10. The system as in claim 1, wherein the calibration workpiece is shaped as a gas turbine engine component.

11. The system as in claim 10, wherein the calibration workpiece is shaped as a stator vane or a turbine rotor blade component of the gas turbine engine.

12. The system as in claim 10, wherein at least one of the plurality of sensors is disposed along at least one of a leading edge, a trailing edge, a tip portion or a root portion of the stator vane or the turbine blade, or a base portion of the calibration workpiece.

13. The system as in claim 1, further comprising a remote operatively connected to the laser housing by a power cable.

14. The system as in claim 1, wherein the controller is programmed to record laser light intensity based on the signal generated by the laser sensors.

15. A method for checking calibration of a robotic multi-axis machine, the method comprising:
coupling a laser pointer to a machine tool mounted to a distal end of a robotic arm of a robotic multi-axis machine; and
initiating a calibration program programmed into the controller which instructs the robotic multi-axis machine to point the laser pointer towards a laser sensor disposed along an outer surface of a calibration workpiece and to generate a laser beam via a laser of the laser pointer;
wherein if the laser sensor detects the laser beam the laser sensor generates a signal which is transmitted back to the controller and the controller records the signal.

16. The method as in claim 15, further comprising translating the calibration workpiece via a multi-axis mounting table.

17. The method as in claim 15, further comprising detecting intensity of the laser beam via the laser sensors and determining calibration drift based on the intensity of the laser beam.

18. The method as in claim 15, further comprising producing a printout or an electronic display indicating calibration status based on the signals generated or not generated by of the laser sensors.

19. The method as in claim 15, further comprising, removing the laser pointer from the machine tool upon completion of the calibration program and replacing the laser pointer with a spray nozzle.
